(19) United States
(12) Patent Application Publication
(10) Pub. No.: US 2008/0183591 A1
(43) Pub. Date: Jul. 31, 2008

(54) System for partner engagement in commercial distribution of digital porducts

(75) Inventors: Hakan Olsson, Kirkland, WA (US); Alex A. Kipman, Duvall, WA (US); Joshua Kriesberg, Seattle, WA (US); Mark Svancarek, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/700,418

(22) Filed: Jan. 31, 2007

(51) Int. Cl. G06Q 30/00

(52) U.S. Cl. 705/26

(57) ABSTRACT

A developer of digital products can provide one or more digital products for sale to a user, some of which are not purchased or active. Subsequently, when a user desires to purchase such digital products, only a license file needs to be provided to the user. To encourage such bundling, the bundler, such as a hardware manufacturer can include identifiers to enable a referral payment to be paid to the manufacturer. Similarly, identifiers of a merchant of record can be included to direct the user to a specific merchant for the sale. To streamline the management of digital licenses, an authorized merchant can be used to provide digital licenses upon purchase, even if the sale was completed with a merchant of record.

### BACKGROUND

Coincident with the growth of the sales and use of computing devices has been the growth of the sales and use of digital products on such computing devices. While sales of software or, more generically, any collections of computer-executable instructions, have been well associated with the sales of computing devices, other types of digital products have likewise been sold for use on computing devices. Such digital products, often comprised primarily of valuable data, as opposed to executable instructions, can include products such as digital encyclopedias, digital image libraries, digital typographic and font libraries, and other similar products. Traditionally, the vast majority of such digital products, including software, have been sold via physical distribution mechanisms. For example, many digital products are written to computer-readable media, such as magnetic or optical media, and are subsequently packaged into a retail container, often with supporting documentation or other materials. These retail containers are printed with appropriate marketing information and are displayed and sold as the digital product itself. Indeed, many consumers do not distinguish between the digital product itself and its physical retail marketing package.

The retail package, however, adds costs to the distribution of digital products, including the manufacturing costs of the package itself and its contents, the shipping costs associated with providing the retail package to retailers and, ultimately, to consumers, and the storage costs of warehousing the retail package. Consequently, as worldwide networking technology has improved, and especially as network communication throughput has increased, the sale of digital products through online mechanisms has become more prevalent. By selling digital products online, the retail package is essentially eliminated. Instead, the computer-readable information that comprises the digital product is transmitted to the consumer across a network connection and is stored on computer-readable media the user already owns. Digital version of manuals or other materials often included in the retail package can likewise be provided across the network, enabling the user to view such materials via their computing device.

By some estimates online sales of digital products are growing at a very fast pace, especially when compared to the sales grown of digital products as a whole. Nevertheless, digital products sold via traditional retail channels continue to comprise a majority of the sales of digital products as a whole. The popularity of the sale of digital products via traditional retail channels can, in part, be traced to the existence of more complex business arrangements. For example, in traditional retail channels, digital products can be sold in bundles comprising additional digital products from other developers, hardware products from other manufacturers, or both. Modern personal computing devices, for example, are often sold bundled with digital products from one or more developers. The sale of such a personal computing device entails a carefully negotiated relationship between the manufacturer of the personal computing device and the one or more developers whose products are bundled with the personal computing device. Online sales of digital products can offset the negotiated relationship and can render such bundles less desirable to either, or both, the manufacturer of the personal computing device and the developer of the bundled digital products.

### SUMMARY

A developer of digital products that are to be bundled, for example, with computing hardware, can provide such products to the hardware manufacturer. In one embodiment, a single version of a digital product can be provided such that only a trial version of the product is technically included with the bundle, and the full version of the digital product can be purchased at a later time. In another embodiment, multiple versions of a digital product family can be provided such that one version of the product can be bundled and the remaining versions can be purchased, or upgraded to, at a later time. Examples of multiple versions of a digital product family include software that is sold in both a basic version and in more powerful versions that build upon the features of the basic version. Examples of multiple versions of a digital product family also include multiple versions of a digital typeface, or even multiple typefaces, multiple collections of clip art, or other like collections of artistic efforts that are sold individually.

The manufacturer can bundle the one or more digital products provided and can add identifying information to the bundle. In one embodiment, such identifying information can comprise an identifier of the manufacturer to enable the developer of the digital products to provide a referral payment or other payment to the manufacturer. In another embodiment, such identifying information can further comprise an identifier of a merchant of record to which the user or purchaser of the bundle should be directed to further upgrade the digital products contained within the bundle. By providing an identifier of a merchant of record, the manufacturer can bundle digital products from various developers without needing to maintain the overhead to provide after-sale upgrades for the digital products from those developers included in the bundle.

In one embodiment, the manufacturer can sell the bundle directly to consumers while, in another embodiment, the manufacturer can provide the bundle to retailers, who, in turn sell the bundle to consumers. In the latter embodiment, the retailers can themselves add a merchant of record identifier to the bundle to, for example, ensure that subsequent upgrades or purchases of digital products contained in the bundle are directed to that retailer.

Once the end user has received the bundle, they can be presented with an option to purchase additional digital products contained within the bundle or to upgrade the digital products in the bundle. In one embodiment, a digital product in the bundle can be a basic version of the digital product and the user can be presented with the option to upgrade to a more advanced version. In another embodiment, a digital product in the bundle can be a demonstration version and the user can be presented with the option to upgrade to a full version. In a still further embodiment, the user can be presented with the option to purchase a digital product associated with a digital product already available to the user in the bundle. For example, the user can be provided with the option to purchase more typefaces to add to the typefaces provided in the bundle.

Once the user selects to purchase or upgrade one of the digital products, a redirect service can be provided with the identifiers added to the bundle, such as by the manufacturer or retailer. The redirect service can also be provided with information relevant to the user's upgrade or purchase selection, such as the digital product selected, the version currently owned by the user, the version requested by the user, the geographic location of the user, the default language set by the user, or other relevant information. Based upon the information provided, the redirect service can select an appropriate destination for the user's upgrade or purchase request and can inform the destination of the exact product requested by the user. Consequently, the choices that the user is forced to make are minimized, and the transaction is more efficient for the user. The exact product identified by the redirect service can take into account the geographic region of the user, the user's language preferences, the product the user selected to purchase or upgrade to, the existing product licensed by the user, and other relevant information, such as new product announcements that can be provided from the digital product developer to the redirect service directly.

In one embodiment, the redirect service can redirect the user's request to upgrade or purchase digital products to the merchant of record identified in the bundle of digital products. In another embodiment the redirect service can redirect the user's request to an authorized merchant that is authorized to sell the requested upgrade or purchase on behalf of the merchant of record. Thus, if the developer of the digital product only allows specific entities to sell their products, the merchant of record identified by either the manufacturer or the retailer can still receive the benefit of the sale while the communications with the user, and delivery of the license, can be performed by an authorized merchant selected by the developer of the digital product.

Once the user has paid for the requested digital product or the requested upgrade, the user can receive a digital license to the digital product or upgrade. Such a license can activate digital components already present in the bundle owned by the user. Thus, in one embodiment, user would not be required to download any additional data beyond the digital license itself. The user's computing device can accept the digital license and store it in a predefined location and can also activate the relevant digital components already present in the bundle previously purchased by the user. To prevent fraud, the digital license can be encrypted and can be stored in a secure manner. In one embodiment, the digital license is provided to the user's computing device only from an authorized merchant to enable the developer of the digital product to more easily and securely manage and track outstanding licenses. In an alternative embodiment, the merchant of record can provide the digital license to the end user.

If only an authorized merchant can provide digital licenses and if the user was directed by the redirect service to a merchant of record, then the merchant of record can notify the authorized merchant of the sale of the digital license. The authorized merchant can, thereby, track the digital licenses that are sold, and can provide status notifications to the developer of the digital product. The authorized merchant can also request additional licenses to ensure a continuing supply. If the merchant of record can also provide digital licenses to the end user, then the merchant of record can directly communicate with the developer of the digital product to provide sales notifications and to request additional licenses to ensure a continuing supply.

In one embodiment, whether the redirect service directs the user's purchase or upgrade request to the merchant of record directly or, instead, directs it to an authorized merchant which merely hosts the sale for the merchant of record, the user's payment and relevant information, such as the user's name and billing address, can be directed to the merchant of record. Consequently, once the merchant of record receives the user's payment, the merchant of record can keep their share and provide the rest to the developer of the digital product. Since the merchant of record receives the user's personal information, the merchant of record can seek to sell other products to the user through marketing or up selling or cross selling. In one embodiment, the user can be provided with the merchant of record's privacy policy prior to purchase.

If the authorized merchant was not previously paid by the developer, and if the authorized merchant provided the license to the user, then, in one embodiment, the authorized merchant can receive their share of the payment from the developer after the developer receives payment from the merchant of record. The developer of the digital product can additionally provide a referral payment to the manufacturer to entice the manufacturer to include components of the digital product in the bundle even though those components may not yet be active and may not be part of the digital product that is being purchased with the bundle. In one embodiment, the referral payment to the manufacturer can be provided upon receipt, by the developer of the digital product, of the payment from the merchant of record. In an alternative embodiment, the developer can delay sending the referral payment to the manufacturer until the end user registers the purchased digital product or upgrade.

This Summary is provided to introduce a selection of concepts in a simplified form that are further described below in the Detailed Description. This Summary is not intended to identify key features or essential features of the claimed subject matter, nor is it indented to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a block diagram of an exemplary system for partner engagement in the commercial distribution of digital products;

FIG. 2 is a block diagram of an exemplary computing device;

FIG. 3 is a communicational diagram illustrating an aspect of the exemplary system of FIG. 1;

FIG. 4 is a communicational diagram illustrating another aspect of the exemplary system of FIG. 1;

FIGS. 5a and 5b are communicational diagrams illustrating alternative aspects of the exemplary system of FIG. 1;

FIG. 6 communicational diagram illustrating another aspect of the exemplary system of FIG. 1;

FIG. 7 is a flow diagram illustrating an aspect of an exemplary system for partner engagement in the commercial distribution of digital products;

FIG. 8 is a flow diagram illustrating a further aspect of an exemplary system for partner engagement in the commercial distribution of digital products; and

FIG. 9 is a flow diagram illustrating a still further aspect of an exemplary system for partner engagement in the commercial distribution of digital products.

### DETAILED DESCRIPTION

The following description relates to mechanisms for implementing a partner engagement system for the commercial distribution of digital products. Multiple versions of a digital product family, or multiple digital products can be provided to an end user when the end user purchases only one digital product or version, or a bundle comprising, for example, computing hardware and the digital product. The end user can subsequently be allowed to upgrade to other included versions of the digital product, or to purchase other included digital products. A redirect service can direct purchasing communications from the user to a merchant of record or an authorized merchant based on continuously updated analysis mechanisms provided to the redirect service, and based on information provided from the end user. Upon payment to the merchant of record, the user can receive a digital license to the newly purchased or upgraded digital product, which can enable components of the digital product that were previously provided, but were not active. The user's payment can be transmitted from the merchant of record to the developer of the digital product, which can then further share the user's payment with authorized merchants and with a manufacturer including the digital product with their computing device.

In one embodiment, one or more digital products, or one or more different versions of a single digital product family can already be physically within the user's possession, but remain unactivated. When a user selects to purchase one of the unactivated digital products, or selects to upgrade an active digital product to a version with additional features, that is not yet active, the user's request can be initially sent to a redirect service. To simplify the user's experience, mechanisms on the user's computing device can collect relevant information and provide it with the user's request to the redirect service. Such relevant information can include an identification of the digital product the user is purchasing or upgrading to, an identification of the digital product the user is upgrading from, the geographic area in which the user is located, the user's default language preferences, and any commercial identifiers included with the relevant digital product, such as a manufacturer identifier, a merchant of record identifier, or the like. Based on this relevant information, the redirect service can direct the user's purchase or upgrade request to the appropriate commercial entity.

In another embodiment, digital products can be activated by purchasing and downloading a digital license file that is sold by an authorized merchant, a merchant of record, or both. The developer of the digital products can select to have licenses distributed by either a small group of authorized merchants, a larger group of merchants of record, or both. Based on the preferences of the developer of the digital products, as well as the information in the user's request, the redirect service can direct the user's request to either an identified merchant of record or an appropriate authorized merchant. In some cases, an authorized merchant can host a sale on behalf of a merchant of record to ensure a cohesive user experience across multiple merchants. Once the user purchases or upgrades a digital product, the digital license can be provided from the authorized merchant, even if it was purchased from a merchant of record directly, thereby simplifying the management of digital licenses for the developer of the digital product. Alternatively, the digital license can be provided by the merchant of record directly.

In a further embodiment, the authorized merchant can communicate with the developer of the digital product to provide sales notifications and request additional digital licenses, if appropriate, to ensure a continuing supply. If the digital license was purchased directly from a merchant of record, and is to be provided to the user by an authorized merchant, the merchant of record can notify the authorized merchant of the sale and request that the authorized merchant send the digital license to the user. The merchant of record can also notify the authorized merchant even if the merchant of record is allowed to provide digital licenses in order to centralize record keeping. Once notified, the authorized merchant can take the sale into account when notifying the developer of the digital product. Additionally, once the user's payment is received by the merchant of record, the merchant of record can keep their share of the payment and provide the rest to the developer of the digital product. The developer can then pay the authorized merchant for their services, and can provide a referral payment to the manufacturer that created the bundle for the user to encourage the provision of digital product components that are not active.

The techniques described herein focus on, but are not limited to the distribution of digital licenses to digital products already in the user's possession, but which are not active due to the lack of an appropriate digital license. The described techniques provide an architecture whereby financial incentive is provided to multiple participants, thereby enabling the developer of the digital products to sell those digital products merely by selling licenses over networked connections.

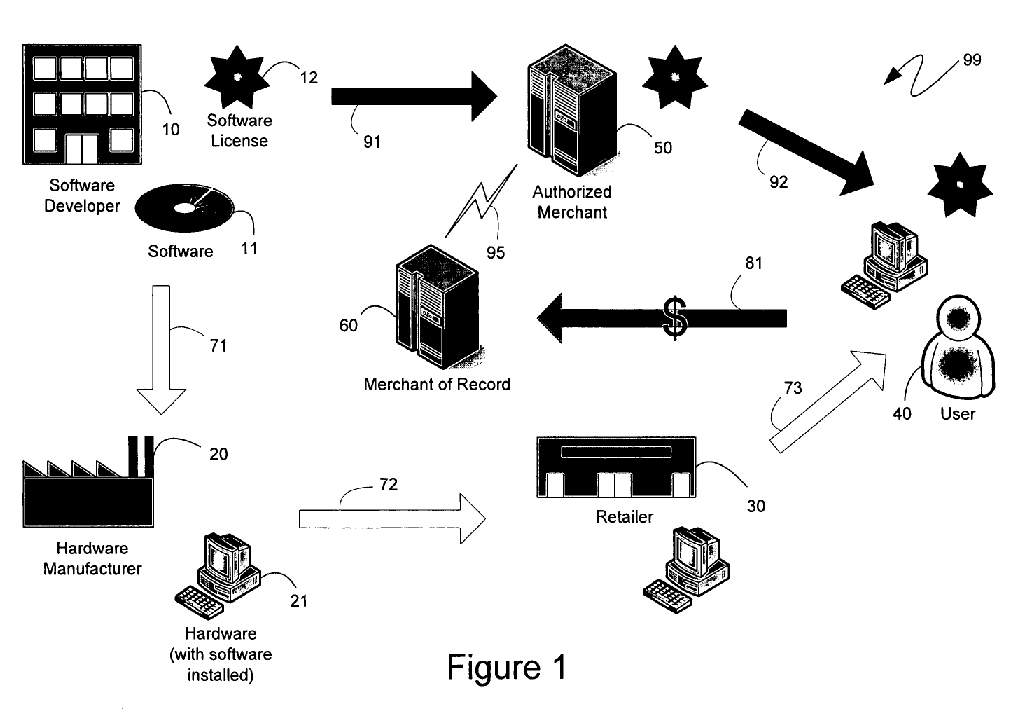

Turning to FIG. 1, an exemplary system 99 is illustrated, comprising, in part, a software developer 10, software 11, developed by the developer, and a user 40 to whom one or more elements of software are to be sold. For simplicity of description, FIG. 1 refers to a software developer 10 and software 11, though, as is clear from the preceding summaries, the present application is directed to the distribution of any type of digital product, not merely software. Examples of other digital products include digital typefaces and fonts, collections of clip art, one or more digital photographs, one or more digital audio compositions, such as songs or sound effects, and other like digital products that are created and sold to users. Thus, while the descriptions below will refer to “software,” they are equally applicable, and are meant to encompass, any digital product that is created and sold to users.

In addition to the software developer 10 and the end user 40, the system 99 of FIG. 1 further comprises a hardware manufacturer 20, computing hardware 21, a retailer 30, an authorized merchant 50 and a merchant of record 60. Again, for simplicity of description, FIG. 1 refers to a hardware manufacturer 20 and computing hardware 21, while the present application, as is clear from the above summaries, is directed to any mechanism by which elements or components of a digital product are provided to a user in an unactivated state. Thus, while the descriptions below will refer to a hardware manufacturer 20, such descriptions are equally applicable to entities that bundle one or more digital products together for purchase by the end user, even if such bundles do not comprise computing hardware. Likewise, while the descriptions below will refer to computing hardware 21, those descriptions are equally applicable to a bundle of one or more digital products, such as, for example, a collection of typefaces or clipart, or a collection of songs or movies.

Initially, as indicated by transfer 71, the software developer 10 can provide the software 11 to a hardware manufacturer 20 for bundling or for inclusion with hardware 21. As part of the bundling, the hardware manufacturer 20 can include an identifier of the hardware manufacturer with the software 11 to enable the software developer 10 to provide financial incentives to the hardware manufacturer for bundling the software 11. The hardware manufacturer can further include an identifier of a merchant of record 60 to direct subsequent purchases or upgrades of the software 11 to a particular merchant. In one embodiment, the identified merchant of record can be the hardware manufacturer 20 themselves, thereby removing the need for a separate identifier. Additional identifiers can also be added to the software 11 or hardware 21 bundle by the hardware manufacturer 20.

Once bundled, the hardware 21 and software 11 can be sent, as indicated by transfer 72, to a retailer 30. In one embodiment, the retailer 30 can modify identifiers that are part of the software 11. For example, the retailer 30 can modify the merchant of record identifier specifying that the merchant of record 60 is the retailer 30, thereby providing additional sales for the retailer 30.

A user 40 can then purchase 73 the hardware 21, with the software 11 included, from the retailer 30. Subsequently, the user can be decide to upgrade the software 11 to, for example, a more feature-rich version of the software 11. Alternatively, the user 40 can decide to purchase additional elements of the software, such as specialized utilities, additional typefaces, and the like. In one embodiment, the software 11 comprises elements that can encourage or aid the user's purchase or upgrade decisions. For example, the software 11 can comprise an upgrade utility that can be executed by the user 40 to upgrade the software 11. Such a utility can comprise a guide to aid the user 40 in determining which upgrade may be more beneficial to the user. Alternatively, the software 11 can comprise demonstration versions that eventually require the user to purchase a non-demonstration, or “full,” version.

The upgrade or purchase utility can collect information from the hardware 21 and software 11 and include such information in the upgrade or purchase request. The collected information can be tailored to aid processes external to the hardware 21 and enable those processes to determine the user's requirements with a minimum of effort on the part of the user 40. The collected information can include an identification of the software 11 that the user already has purchased, the new software the user wishes to purchase or upgrade to, the geographical location in which the user is located, the default language selected by the user on the hardware 21, and any other information that can aid in identifying the correct new software the user wishes to purchase or upgrade to.

In one embodiment, the upgrade or purchase utility communicates with a redirect service, not shown in FIG. 1, to aid in the ultimate transaction 81 between the user 40 and the merchant of record 60. More specifically, the redirect service can be continually updated to interpreted the information provided by the upgrade or purchase utility to enable a seamless experience for the user. For example, if the user's geographic location is Geneva, Switzerland, the redirect service can interpret the geographic location information provided by the upgrade or purchase utility, and select the German version of the new software which the user 40 is upgrading to or purchasing (since 60% of Switzerland lists German as their native language). A subsequent update to the redirect service can provide greater interpretational abilities so that, even with the same request, the newly updated redirect service can recognize that Geneva, Switzerland is primarily French-speaking and can, consequently, select the French version of the new software which the user 40 is upgrading to or purchasing.

The updatability of the redirect service further provides a greater range of options when selecting the merchant that is to receive the user's upgrade or purchase request. For example, the software developer 10 can select an authorized merchant 50 that is trusted to manage and distribute the digital software licenses 12. The authorized merchant 50 can likewise conform to other standards set by the software developer 10, such as providing a uniform user interface to facilitate purchases or upgrades of the software 11. If the software developer 10 selects such an authorized merchant 50, the redirect service can redirect the user's purchase or upgrade request to the authorized merchant 50. In one embodiment, the authorized merchant 50 can then host the sale or upgrade on behalf of the merchant of record 60 whose identifier was added to the software 11, and which was provided as part of the user's request. For example, the authorized merchant 50 can provide an interface, such as through a web page, that appears to the user 40 to be a web page of the merchant of record 60.

As a result, the transaction 81 can be thought of as occurring between the user 40 and the merchant of record 60, with the merchant of record directly receiving the user's payment and other relevant information, such as the user's name and billing address. The merchant of record 60 can use this information to make additional sales to the user 40, such as by providing targeted marketing to the user after transaction 81 is complete. The merchant of record 60 can likewise seek to make additional sales to the user 40 by identifying what the user is purchasing and offering additional relevant items, such as memory upgrades if the user is purchasing a license to a new operating system, or a joystick if the user is purchasing a license to a game. The merchant of record 60 can be constrained in these actions by their “privacy policy,” which, in one embodiment, can be presented to the user 40 prior to engaging in transaction 81 with the merchant of record.

If the software developer 10 does not require that sales or upgrades be hosted by the authorized merchant 50, the redirect service can redirect the user's purchase or upgrade request to the merchant of record 60 whose identifier was added to the software 11, and which was provided as part of the user's request. The transaction 81 can then take place directly between the merchant of record 60 and the user 40 without the interactions of the authorized merchant 50. In one embodiment, however, the digital license 12 is still managed by, and provided from, the authorized merchant 50. Consequently, after completing transaction 81, the merchant of record 60 can notify the authorized merchant 50 of the transaction via communications 95.

Whether the transaction 81 was handled entirely by the merchant of record 60, or whether the user's purchase or upgrade request was originally redirected to the authorized merchant 50, in one embodiment, the license 12 is provided to the user 40 by the authorized merchant 50 via communication 92. Once received by the computing device used by the user 40, the license 12 can be stored in a secure fashion. For example, the computing device used by the user 40 may have dedicated mechanisms for securely receiving digital licenses, such as license 12, storing such a license in a secure manner, and activating the corresponding software 11. Thus, once the license 12 is received, aspects of the software 11 which were previously dormant, can become active and functional. The user 40 can, thus, select to upgrade or purchase software 11 without downloading anything more than a license file 12 since the relevant aspects of the software 11 were already delivered to the user when the user purchased the hardware 21 from the retailer 30.

If software 11 comprises inactive software, however, it will require a greater amount of storage space from the hardware 21. Consequently, the hardware manufacturer 20 may be reluctant to provide inactive software elements with the hardware 21 just so that the software developer can more easily sell post-purchase upgrades or additional purchases to the user 40. To entice the hardware manufacturer 20, the software developer 10 can provide a financial incentive.

Once the merchant of record 60 has received the user's payment via transaction 81, the merchant of record can keep their share, and can forward the remaining payment to the software developer 10. Upon receipt of such payment, the software developer 10 can provide a referral payment to the hardware manufacturer 20 as an incentive to include inactive software elements with the hardware 21. In another embodiment, the referral payment from the software developer 10 to the hardware manufacturer 20 can be paid only after the user 40 registers the newly purchased or upgraded software. As indicated previously, the hardware manufacturer 20 can include an identifier when bundling the software 11 with the hardware 21. Such an identifier can be provided to the redirect service as part of the user's upgrade or purchase request, and can thus be provided to either the merchant of record 60 or the authorized merchant 50, depending on the redirection provided by the redirect service. Subsequently, either the merchant of record 60 or the authorized merchant 50 can provide the identifier to the software developer 10 when informing the software developer of the sale of the license 12, thereby enabling the software developer to identify the hardware manufacturer 20 as deserving of a referral payment for the sale of the license.

In order for the authorized merchant 50 to provide the user 40 with the license 12, the authorized merchant can first receive the license from the software developer 10. Such licenses can be delivered in advance in large groupings to the authorized merchant 50, or they can be requested and delivered in smaller quantities in response to prior purchases. Communication 91 of FIG. 1 illustrates the delivery of license 12 from the software developer 10 to the authorized merchant 50 prior to the sale, and delivery, of the license to the user 40. The authorized merchant 50 can also receive an advanced payment with the license 12, or the authorized merchant can receive payment once license 12 is sold, in the same manner as the hardware manufacturer 20.

Although not required, the descriptions below will be in the general context of computer-executable instructions, such as program modules, being executed by one or more computing devices. More specifically, the descriptions will reference acts and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to conventional personal computers, and include other computing configurations, including hand-held devices, multi-processor systems, microprocessor based or programmable consumer electronics, network PCs, minicomputers, mainframe computers, and the like. Similarly, the computing devices need not be limited to a stand-alone computing devices, as the mechanisms may also be practiced in distributed computing environments where tasks are performed by remote processing devices that are linked through a communications network. In a distributed computing environment, program modules may be located in both local and remote memory storage devices.

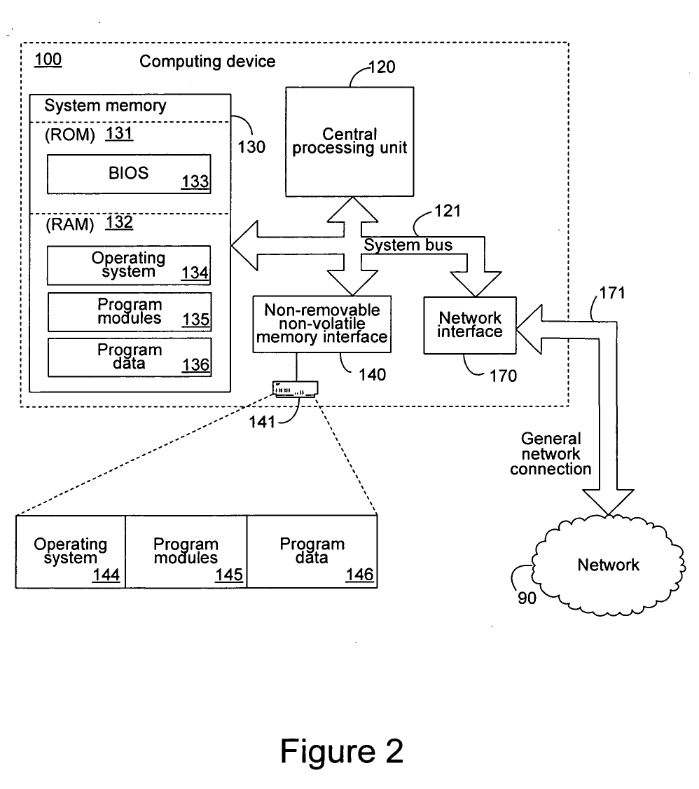

With reference to FIG. 2, an exemplary computing device 100 is illustrated. The computing device 100 can represent the hardware 21 of FIG. 1 and can similarly represent the illustrated computing devices belonging to the merchant of record 60 and the authorized merchant 50. The exemplary computing device 100 can include, but is not limited to, one or more central processing units (CPUs) 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures.

The computing device 100 also typically includes computer readable media, which can include any available media that can be accessed by computing device 100 and includes both volatile and nonvolatile media and removable and non-removable media. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 100. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computing device 100, such as during start-up, is typically stored in ROM 131. RAM 132 typically contains data and/or program modules that are immediately accessible to and/or presently being operated on by processing unit 120. By way of example, and not limitation, FIG. 2 illustrates an operating system 134, other program modules 135, and program data 136.

The computing device 100 may also include other removable/non-removable, volatile/nonvolatile computer storage media. By way of example only, FIG. 2 illustrates a hard disk drive 141 that reads from or writes to non-removable, nonvolatile magnetic media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140.

The drives and their associated computer storage media discussed above and illustrated in FIG. 2, provide storage of computer readable instructions, data structures, program modules and other data for the computing device 100. In FIG. 2, for example, hard disk drive 141 is illustrated as storing an operating system 144, other program modules 145, and program data 146. Note that these components can either be the same as or different from operating system 134, other program modules 135 and program data 136. Operating system 144, other program modules 145 and program data 146 are given different numbers hereto illustrate that, at a minimum, they are different copies.

Of relevance to the descriptions below, the computing device 100 may operate in a networked environment using logical connections to one or more remote computers. For simplicity of illustration, the computing device 100 is shown in FIG. 2 to be connected to a network 90 that is not limited to any particular network or networking protocols. The logical connection depicted in FIG. 2 is a general network connection 171 that can be a local area network (LAN), a wide area network (WAN) or other network. The computing device 100 is connected to the general network connection 171 through a network interface or adapter 170 which is, in turn, connected to the system bus 121. In a networked environment, program modules depicted relative to the computing device 100, or portions or peripherals thereof, may be stored in the memory of one or more other computing devices that are communicatively coupled to the computing device 100 through the general network connection 171. It will be appreciated that the network connections shown are exemplary and other means of establishing a communications link may be used.

The program modules 145 stored on the hard disk drive 141 of computing device 100 can comprise both active program modules and program modules that have not yet been activated. In one embodiment, program modules 145 are activated based on the presence of a valid license and an appropriate indication within the operating system 144. Thus, the program data 146 can comprise one or more digital license files whose presence, and, optionally, location, can be noted within the appropriate sections of the operating system 144. An attempt to execute one or more program modules 145 can result in the running instance 135 checking the operating system 144 for an indication of a valid license file. If such a file exists, program modules 135 can continue executing, while if such a file does not exist, the in memory program modules 135 can be terminated without performing useful work for the user 40. Consequently, the mere physical present of program modules 145 on the computing device 100 is not necessarily synonymous with the user's ability to execute all such programming modules.

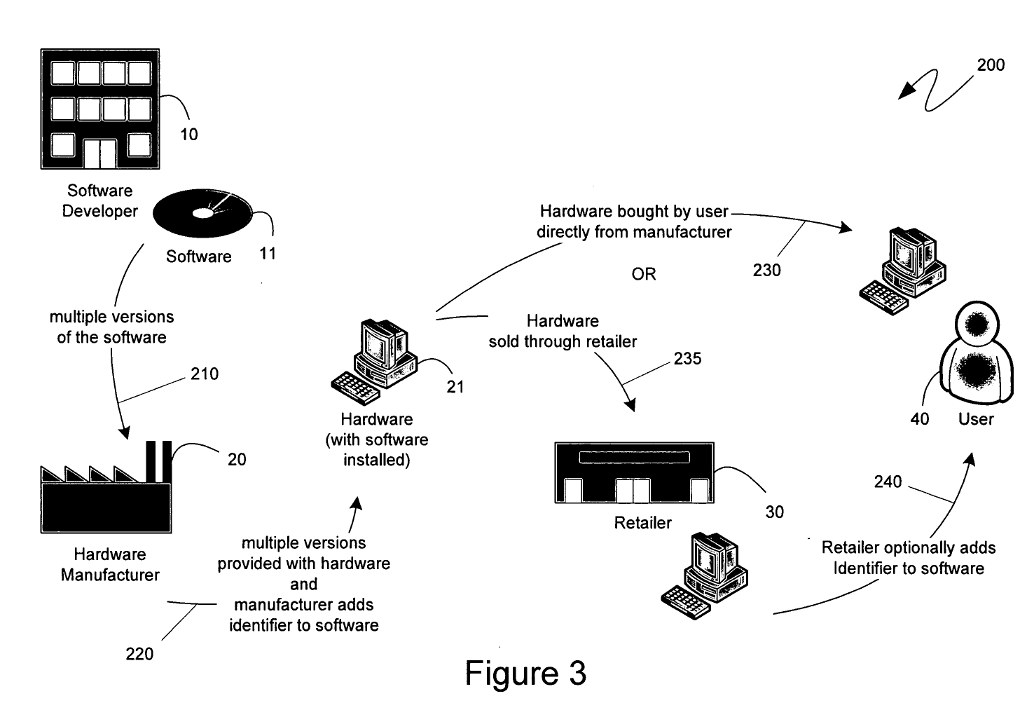

Turning to FIG. 3, a communicational diagram 200 is shown illustrating one mechanism for providing for online sales of software 11. Initially, multiple versions of the software 11 can be provided by the software developer 10 to the hardware manufacturer 20 via communication 210, as shown. The multiple versions provided need not all be active, and at least some of the versions provided can remain inactive so as to be subsequently sold in the manner described further below. For example, the software 11 can be developed into a basic version having a standard set of features, and an “ultimate” version sharing the same standard set of features as the basic version, but adding additional features. Both versions can be included as part of the software 11 delivered to the hardware manufacturer 20 via communications 210, but only the basic version can have an appropriate license file. Similarly, software 11 can comprise a suite of individual applications, such as a word processor, a spreadsheet, a presentation program, an email program, and a graphics program. One or more of these individual applications can lack an appropriate license file as delivered to the hardware manufacturer 20, thereby affording the software developer 10 the opportunity to sell the unactivated applications online to the user 40 after the user has purchased the hardware 21.

Once the software 11 is received, the manufacturer 20 can install some or all of the multiple versions, or multiple applications, of the software onto the hardware 21 or other bundle being manufactured by the manufacturer. As indicated previously, installing elements of the software 11 that are not activate, and are not being sold by the hardware manufacturer 20, can require the investment of resources, such as storage resources, from the hardware manufacturer 20. To provide an incentive for cooperation, the financial benefits of subsequent sales of the elements of the software 11 that were not active can be shared, by the software developer 10 with the hardware manufacturer 20. Thus, in one embodiment, the hardware manufacturer 20 adds an identifier to the software 11, or otherwise stored on the hardware 21, linking the particular copy of the software and the particular hardware to the hardware manufacturer. The installation of the software 11 onto the hardware 21, and the adding of the manufacturer identifier is illustrated by transfer 220 of FIG. 3.

Once the bundle has been completed by the manufacturer 20, the manufacturer can either sell the hardware 21 to the user 40 directly, as indicated by the sale 230 of FIG. 3, or the manufacturer can provide the hardware to the retailer 30, as indicated by transfer 235. If the manufacturer 20 sells the hardware 21 through a retailer 30, the manufacturer 20 can have the option, as part of the transfer 220, to include, not only a manufacturer identifier, but also a merchant of record identifier. In one embodiment, the merchant of record identifier can identify the retailer so that the manufacturer 20 can still receive referral payments from the developer 10, but that the retailer 30 can receive additional purchase requests or upgrade requests from the user 40. Such a merchant of record identifier can also, optionally, be added by the retailer 30 themselves, depending, for example, on the negotiated relationship between the manufacturer 20 and the retailer. FIG. 3 illustrates the retailer 30 optionally adding an identifier prior to the sale 240 of the hardware 21 to the user 40.

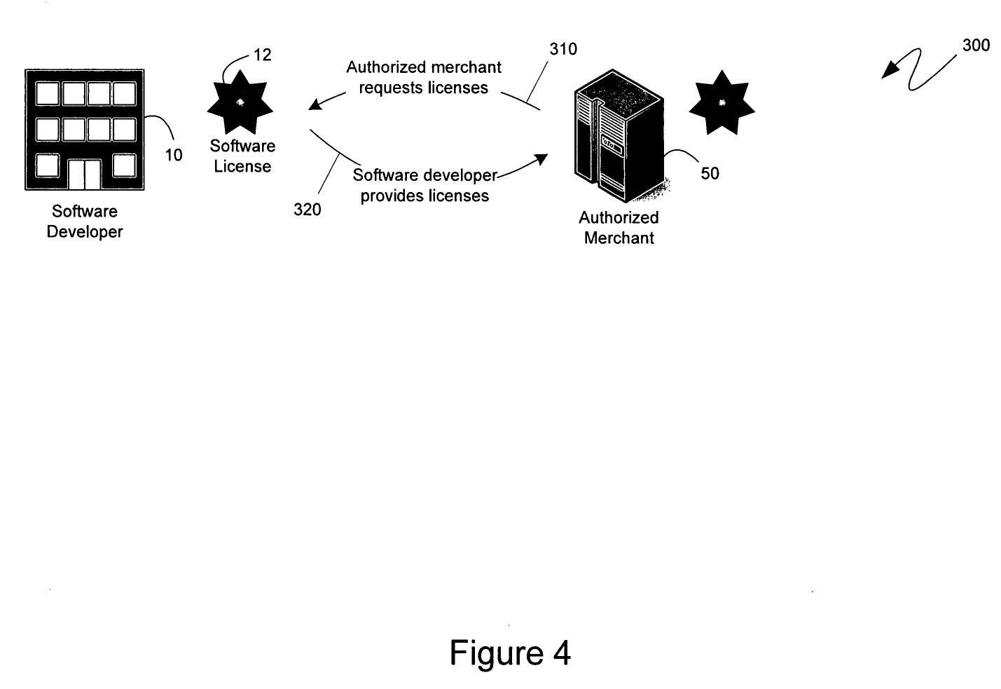

Unconnected with the provision of the software 11 to the user 40 illustrated in FIG. 3, the software developer 10 can also distribute digital licenses for one or more of the elements or applications of the software 11 that were provided to the hardware manufacturer 20 in a deactivated state. Thus, as shown in FIG. 4, the software developer 10 can select, such as through a screening or licensing program, one or more “authorized merchants,” such as authorized merchant 50, that are empowered to store multiple digital licenses 12 for one or more applications or elements of the software 11, and to provide those digital licenses upon completion of an appropriate purchase by the user 40.

Turning to FIG. 4, a communicational diagram 300 is shown illustrating an exemplary series of communications between a software developer 10 and an authorized merchant 50 providing digital software licenses 12 to the authorized merchant. In one embodiment, the authorized merchant 50 can initiate a request 310 for license 12 from the software developer 10. The request 310 can be initiated whenever the supply of licenses at the authorized merchant 50 falls below a threshold level, or it can be initiated based on one or more sales events, such as will be described below. In response 320, to request 310, the software developer 10 can provide the requested software licenses, such as license 12, to the authorized merchant 50. In an alternative embodiment, the software developer 10 can initiate communication 320 without first receiving a request 310 from the authorized merchant 50.

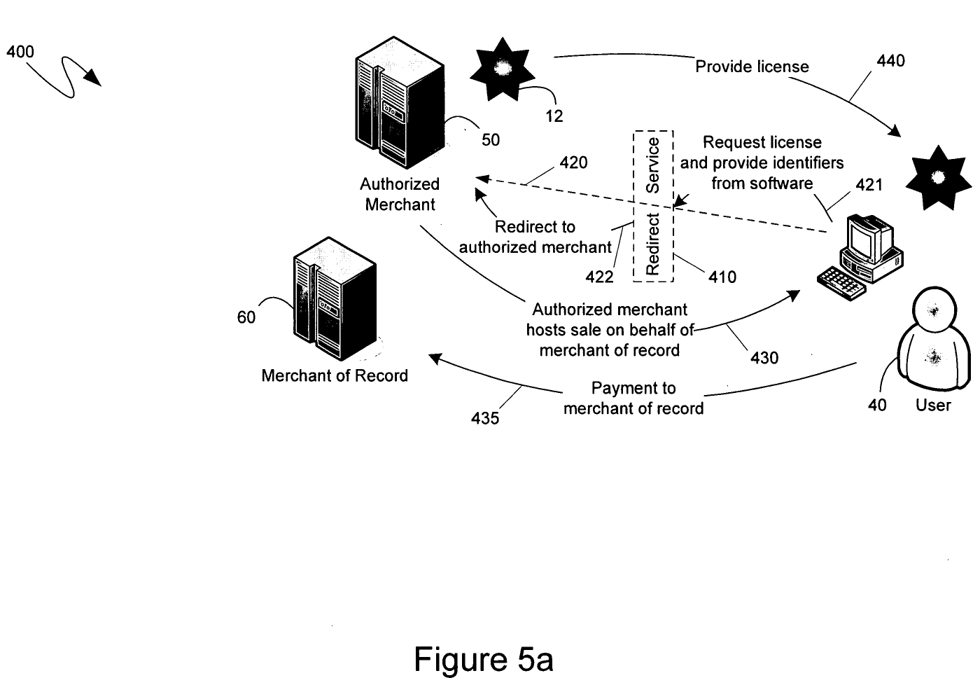

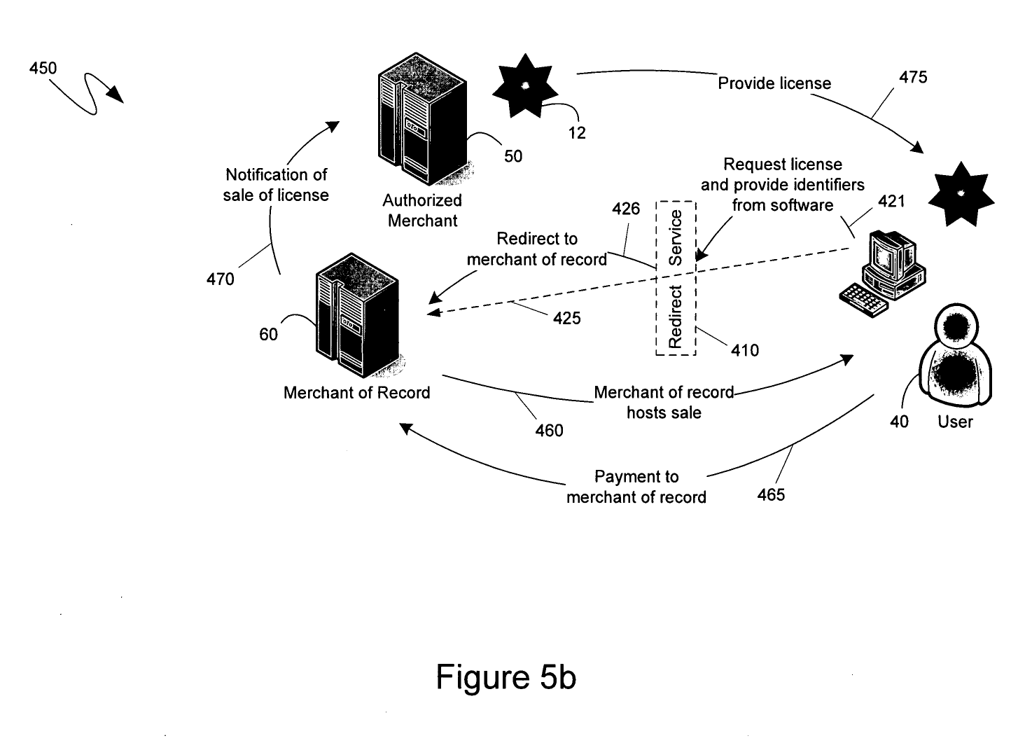

While the software developer 10 may select one or more authorized merchants, such as authorized merchant 50, to distribute the digital software licenses, such as license 12, the software developer can also provide a mechanism by which the merchant of record selected by the manufacturer 20 or the retailer 30 can provide the sale of the digital license. Turning to FIG. 5a, one such mechanism is illustrated by communicational diagram 400. As shown, the user 40 can initiate a request 421 to purchase additional aspects of the software 11 already present on the user's computing device, though some components are not yet activated.

In one embodiment, the request 421 can be initiated by an explicit action by the user 40 to purchase additional aspects of the software 11. For example, if the software 11 comprised a productivity suite of applications, the user 40 can use a utility provided with the suite to select one or more applications in the suite to purchase. Such a utility would provide communication 421. Alternatively, the request 421 can be initiated by prompting from the software 11. For example, if the software 11 comprised both a basic and an ultimate version of a software product, elements of the software 11 could periodically remind the user 40 of the benefits of upgrading from a basic version to the ultimate version. In such a case, the same elements of the software 11 used for marketing purposes, can likewise form the communication 421. In either case, the user 40 can be presented with more detailed marketing information, at the user's request, to guide the user in selecting which product to purchase or upgrade into. For example, the user can be presented with a comparison matrix illustrating the major features of each version available for the user to upgrade into.

Once the user 40 has initiated a purchase or an upgrade, the request 421 can be transmitted to a redirect service 410. As indicated in FIG. 5a, the request 421 comprises identifiers from the software 11 or the hardware 21. Such identifiers can include the identifiers provided by the hardware manufacturer 20, the retailer 30, or any other entity that had access to the software 11 or the hardware 21. The identifiers provided with the request 421 can further include identifiers that can aid in the selection and presentation of the proper digital product to the user 40 for purchase. For example, the identifiers provided with the request 421 can include a geographic region identifier to aid in the selection of the proper product if the developer 10 produces multiple geographic-specific versions of the software 11. The identifiers provided with the request 421 can likewise include a default language identifier to aid in the selection of the proper product if the developer 10 produces versions of the software 11 in multiple languages. Identifiers of the software 11 currently in the user's possession, and of the software desired by the user can also be provided as part of the request 421 to enable the redirect service 410 to verify that the upgrade or purchase requested by the user is proper. For example, if the software 11 comprised a productivity suite of applications, the user 40 may not be allowed to purchase the email application without also either owning or purchasing the word processing application.

The request 421 can, in one embodiment, be configured in accordance with the Hyper-Text Transfer Protocol (HTTP). Thus, the request 421 can be an HTTP GET request providing a detailed Uniform Resource Locator (URL) listing the relevant identifiers. The redirect service 410 can parse the URL to obtain the provided identifiers and can, based on those identifiers, and the updatable knowledgebase of the redirect service itself, select an appropriate destination for the request 421. In the exemplary communicational diagram 400 illustrated in FIG. 5a, the redirect service 410 redirects the request 421 to an authorized merchant 50, as shown by message 422. Because the redirect service 410 is transparent to the user 40, however, the user perceives communication 421 as communication 420 directly to the authorized merchant 50.

In one embodiment, the redirect service 410 can be in communication with the software developer 10, and optionally with other authorized merchants and merchants of record, to maintain an up-to-date knowledgebase, which the redirect service can use to more intelligently redirect communication 421 and to more intelligently interpret the information contained within communication 421. For example, the redirect service 410 can monitor the communicational status of the authorized merchant 50 such that, if the redirect service detects that the authorized merchant is experiencing communicational problems, the redirect service can redirect communication 421 to a different authorized merchant. The redirect service 410 can also incorporate updated information from the software developer 10 when interpreting the information contained within message 421. For example, the software developer 10 can specify which language-specific product is to be selected given a particular geographic location. Thus, if, for example, the user's geographic location is Geneva, Switzerland, the redirect service can interpret this geographic location information, which would have been provided in message 421, and select the German version of the new software which the user 40 is upgrading to or purchasing, since the software developer 10 can have specified that users located in Switzerland should be offered the German version. After evaluating customer feedback, the software developer 10 can determine that the language-specific version of the software 11 should be selected with finer granularity and can update the redirect service 410 accordingly. If the message 421 was received by an updated redirect service 10, the newly updated redirect service could, for example, recognize that Geneva, Switzerland is primarily French-speaking and could, as a result, select the French version instead of the German one.

In the embodiment illustrated in FIG. 5a, the redirect service 410 redirects communication 421 to the authorized merchant 50 via communication 422, in a manner that is essentially transparent to the user 40, who, instead, perceives a single communication 420 directly to the authorized merchant. In response to this perceived communication 420, the authorized merchant 50 can, in one embodiment, host the sales transaction on behalf of the merchant of record 60. As indicated, the communication 421 can comprise an identifier of a merchant of record that can have been provided by the manufacturer 20 or the retailer 30. As a business proposition, it may be undesirable for the software developer 10 request the cooperation of the manufacturer 20 and the retailer 30 to sell upgrades or additional products online, and then ignore the explicit request of the manufacturer or the retailer to use a particular merchant when selling such upgrades or additional products. Consequently, the authorized merchant 50 can host the sales transaction on behalf of the merchant of record 60, thereby providing for a common user experience consistent with any requirements communicated by the software developer 10 to the authorized merchant 50. For example, the authorized merchant 50 can host a web page that displays information in a particular manner and with a particular level of reliability and security, as may have been specified by the software developer 10. However, such a web page can include the name and logo of the merchant of record 60, and payment information provided by the user 40 through the hosted web page can be sent directly to the merchant of record for processing, rather than first being handled by the authorized merchant 50.

As shown in FIG. 5a, therefore, the user 40 can receive communications 430 whereby the authorized merchant 50 hosts the commercial transaction on behalf of the merchant of record 60. The user's payment 435, however, can be provided directly to the merchant of record 60 without first being transmitted to the authorized merchant 50. Once the user 40 has made the payment 435, the authorized merchant can provide the relevant license 12 to the user via communication 440.

Some merchants of record, such as the merchant of record 60 of FIG. 5b, may be sufficiently large or advanced that they can conform to the software developer's requirements and directly receive user upgrade or purchase requests. Communicational diagram 450 of FIG. 5b illustrates the communication flow with such a merchant of record 60. As shown, upon receipt of message 421, as in FIG. 5a, the redirect service 410 can determine the appropriate destination for the message 421. In the embodiment illustrated in FIG. 5b, the redirect service 410 can parse the message 421, locate a merchant of record identifier, and recognize that the identified merchant of record is allowed to host the transaction themselves. Thus, as shown in FIG. 5b, the redirect service 410 can redirect message 421 to the merchant of record 60 directly, as illustrated by message 426. As previously, the operation of the redirect service 410 can be essentially seamless to the user 40 as illustrated by the perceived message 425 communicating directly with the merchant of record 60.

Unlike in FIG. 5a, the merchant of record 60 of FIG. 5b can host the transaction themselves, and, consequently, communication 460 originates with the merchant of record and not the authorized merchant 50. Upon receipt of communication 460, the user 40 can provide payment 465 and, as before, the authorized merchant 50 can transmit a digital license 12 to the user via communication 475. Because the software developer 10 has provided for authorized merchant 50 to manage and distribute licenses, the merchant of record 60, if it is hosting the transaction itself, can notify the authorized merchant of the sale via communication 470. Such a notification 470 can trigger the transmission 475 of the license 12. The notification 470 can further comprise relevant information about the sale, such as the identifiers of message 421, which would have been received by the merchant of record 60 via redirection 426. In an alternative embodiment, the merchant of record 60 can be authorized to distribute licenses itself. In such a case, the communication 475 of the license 12 to the user 40 can have originated with the merchant of record 60, and the communication 470 can be to merely inform the authorized merchant 50 of the sale for record keeping, and license monitoring, purposes.

Once the license 12 has been received by the user 40 or, more accurately, by the computing device being used by the user, it can be stored in a secure manner and linked appropriately, and can, thereby, activate versions or applications of the software 11 whose digital data was already in the user's possession. In one embodiment, the operating system 144 of the user's computing device can comprise dedicated components or utilities that can accept the digital license 12 and store it in a protected area of the hard disk 141. Such utilities can further modify appropriate databases, such as those maintained by the operating system 144 itself, to enable the relevant versions or applications of the software 11 to identify that the license 12 has been added to the computing device and to verify the license. Once the license 12 has been verified, the versions or applications of the software 11 purchased by the user 40 can fully execute and provide services to the user. Thus, by merely providing the license 12, the software developer 10 was able to sell the versions or applications of the software 11 online in an efficient manner since the relevant computer-readable instructions and data that comprised the sold versions or applications of the software was already in the user's possession.

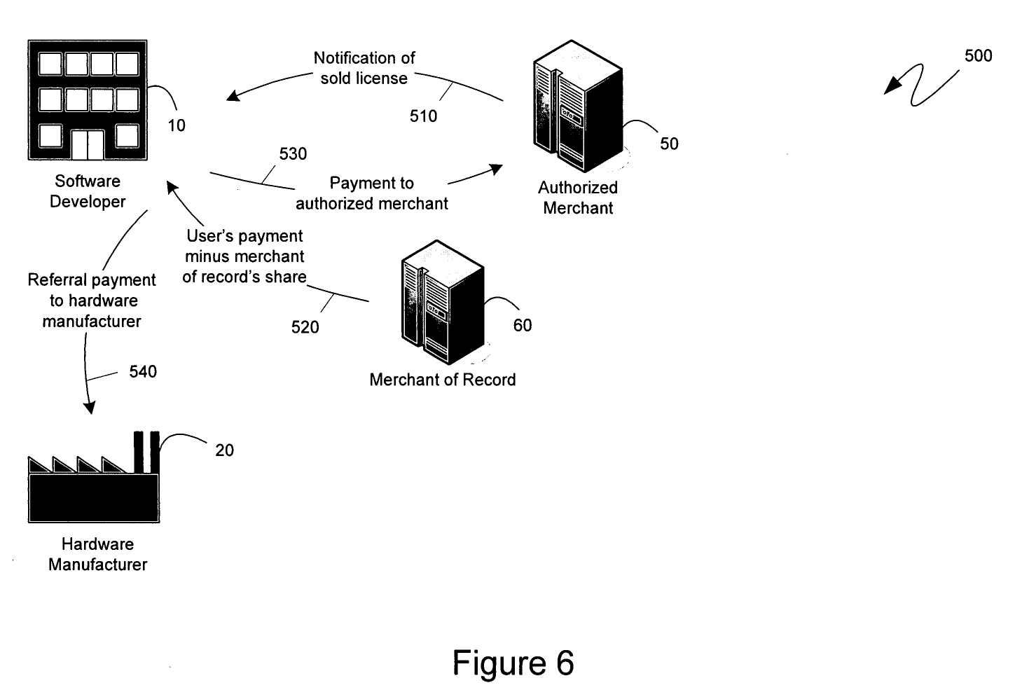

FIG. 6 illustrates a communicational diagram 500 illustrating the receipt of payment by the software developer 10. In particular, once the merchant of record 60 receives the user's payment, the merchant of record can keep their share and can provide the rest to the software developer 10 via payment 520. In addition, at some point, the authorized merchant 50 can notify the software developer 10 of the sale of license 12, via notification 510. In one embodiment, notification 510 can comprise the relevant identifiers that were included in message 421 and ultimately provided to the authorized merchant 50. Based on those identifiers, and optionally other factors as well, the software developer 10 can identify the hardware manufacturer 20 that originally bundled the software 11 that was involved in the online sale. As an incentive to the hardware manufacturer 20, to encourage the hardware manufacturer to invest the resources needed to bundle software that has not yet been activated or purchased, the software developer 10 can provide a financial incentive to the hardware manufacturer 20 in the from of a referral payment 540. In one embodiment, the referral payment 540 can be paid after the software developer receives the payment 520 from the merchant of record 60, while, in an alternative embodiment, the referral payment can be paid only after the software developer 10 receives a registration from the user 40 registering the purchased or upgraded software.

FIG. 6 also illustrates a payment 530 from the software developer 10 to the authorized merchant 50. Such a payment 530 need not be in the form of a referral payment or a per-sale payment, but can instead be a repeating payment for the license delivery and management services provided by the authorized merchant 50. In addition, payment 530 need not be made after receive of the payment 520 from the merchant of record 60, but can, instead, be made upon delivery 91 of the licenses from the software developer to the authorized merchant 50.

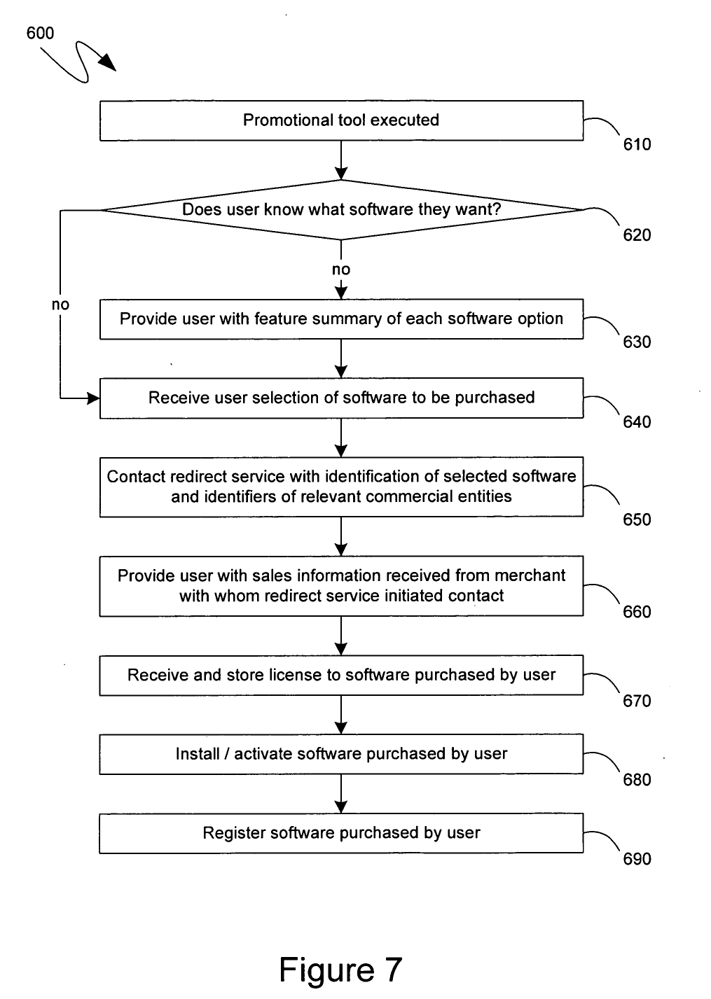

The processing performed by the hardware 21 obtained by the user 40, the redirect service 410, and the software developer 10 is illustrated further by flow diagrams 600, 700 and 800, respectively. Turning to FIG. 7, flow diagram 600 illustrates the steps that can be performed, in one embodiment, by the hardware 21. Initially, at step 610, a “promotional tool” can be executed. The promotional tool can be any component or mechanism that can aid or encourage the user 40 in purchasing or upgrading the software 11. For example, the promotional tool can be a utility provided with a suite of applications indicating which applications have not yet been purchased. As another example, the promotional tool can be more proactive, such as a utility that operates in conjunction with a basic version of the software 11 and, at appropriate times, prompts the user 40 to upgrade to an ultimate version.

Once the promotional tool has been executed at step 610, a determination can be made at step 620 regarding the user's knowledge of purchase or upgrade options. Such a determination can be made by simply presenting the user 40 with the option of electing to receive additional information regarding purchase or upgrade options. Alternatively, the determination of step 620 can be made through more advanced means, such as by providing the user with a questionnaire. If the user is familiar with the relevant options, they can just make a selection at step 640. However, if the user does not understand the purchase or upgrade options, a feature summary and other relevant information can be provided to the user at step 630. For example, the user 40 can be presented with a table comparing the key elements or features of the purchase or upgrade options available to the user. Once the user 40 makes a determination, their selection can be noted at step 640.

At step 650, the user's purchase or upgrade selection can be communicated to the redirect service 410. In one embodiment, identifying information can likewise be presented as part of step 650. Such identifying information can include identifiers of the relevant products to enable the redirect service 410 to determine whether the purchase or upgrade conforms to guidelines that can have been provided by the software developer 10. The identifying information can further comprise manufacturer identifying information, merchant of record identifying information, or both. If present, the merchant of record identifying information can be used by the redirect service 410 to determine the appropriate destination for the user's purchase or upgrade request. In addition, the identifying information can include environmental information, such as the user's geographic location or default language, to enable the redirect service 410 to select the proper incarnation of the digital product which the user is purchasing.

At step 660, the user can be provided with the sales information received from the merchant to whom, ultimately the request from step 650 was forwarded by the redirect service 410. In one embodiment, such sales information can be in the form of a web page. The web page can already have the correct product displayed and selected to simplify the purchase for the user. As indicated, the correct product can have been identified by the redirect service 410 via the identifiers provided at step 650.

Once the user 40 makes the required payment, the license to the purchased digital product can be received and stored at step 670. In one embodiment, utilities executing on the user's computing device can receive and store the digital license 12 in a secure location, and can modify or update appropriate linking information, such as might be contained in an operating system registry. The digital license file 12 can be received by the user 40 via email or downloaded through a web browser or other networkable file transfer application. Modern email clients and web browsers provide for automatic invocation of applications that are assigned to handle a particular type of file. Because a digital license file can have a particular file type, an appropriate application, such as the above described utilities, can be automatically invoked by the email client or web browser upon receipt of the digital license file 12 and can, thus, automatically perform step 670.

In some cases, the mere presence of the digital license 12 on the same computing device as the software 11, along with the appropriate links between the two, such as through the operating system 144, may not be sufficient to active the relevant aspects of the software 11. Instead, as part of step 680, the user may need to perform additional steps to install or activate the software 11 corresponding to the license 12. For example, the user may be required to install some or all of the software from an external disk or other computer-readable medium that was merely shipped with the hardware 21. Alternatively, the user may be required to verify physical ownership of the software 11, such as by entering a multi-digit key often found on the physical container of the software 11. Once the user has installed and activated the software 11 at step 680, they can be free to use the software unencumbered. In many cases, however, the software developer 10 benefits from receiving registration information from the user 40 and, therefore, offers some incentive to the user to entice the user to register. To claim this incentive, the user can register the newly purchased software at step 690.

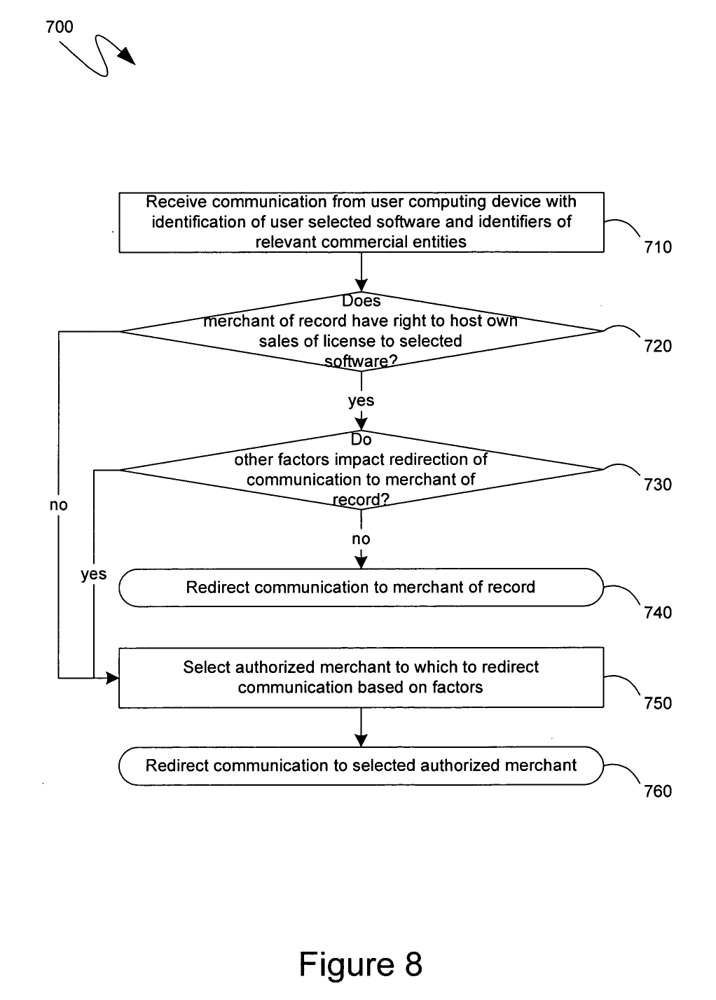

Turning to FIG. 8, a flow diagram 700 is presented, illustrating mechanisms implemented by the redirect service 410. As shown, at step 710, the redirect service 410 can receive a request to upgrade or purchase software along with identification of the relevant software and identification of the relevant commercial entities. In one embodiment, the redirect service 410 seeks to preferentially redirect purchase or upgrade requests to a merchant of record 60 specified via one of the identifiers received at step 710. Thus, at step 720, the redirect service 410 can determine if the identified merchant of record 60 has been granted permission by the software developer 10 to host their own sales of licenses to the software 11 selected by the user 40. If the identified merchant of record 60 does have the appropriate permission from the software developer 10, then the redirect service 410 can determine if there are any other factors that would affect redirection of the communication received at step 710 to the merchant of record 60. Such factors could include, for example, a lack of communication with the merchant of record 60, indicating that the merchant of record is experiencing communicational difficulties. If there are no such other factors at step 730, the redirect service 410 can redirect, at step 740, to the merchant of record 60, the communications received at step 710.

If however, the merchant of record 60, identified by the identifiers received at step 710, is not permitted to host sales of the license requested by the user 40, or if there exist other factors, identified at step 730, the impact the redirection of the user's request to the merchant of record, then the redirect service 410 can select an authorized merchant 50 to which to redirect the user's request at step 750. In selecting an authorized merchant 50 at step 750, the redirect service 410 can take into account a variety of factors, such as the geographic proximity of the authorized merchant based on, for example, geographic information received at step 710, and the current network communicational abilities of the authorized merchant. Once the redirect service 410 selects an appropriate authorized merchant 50 at step 750, then, at step 760, the redirect service can redirect the communications received at step 710 to that authorized merchant.

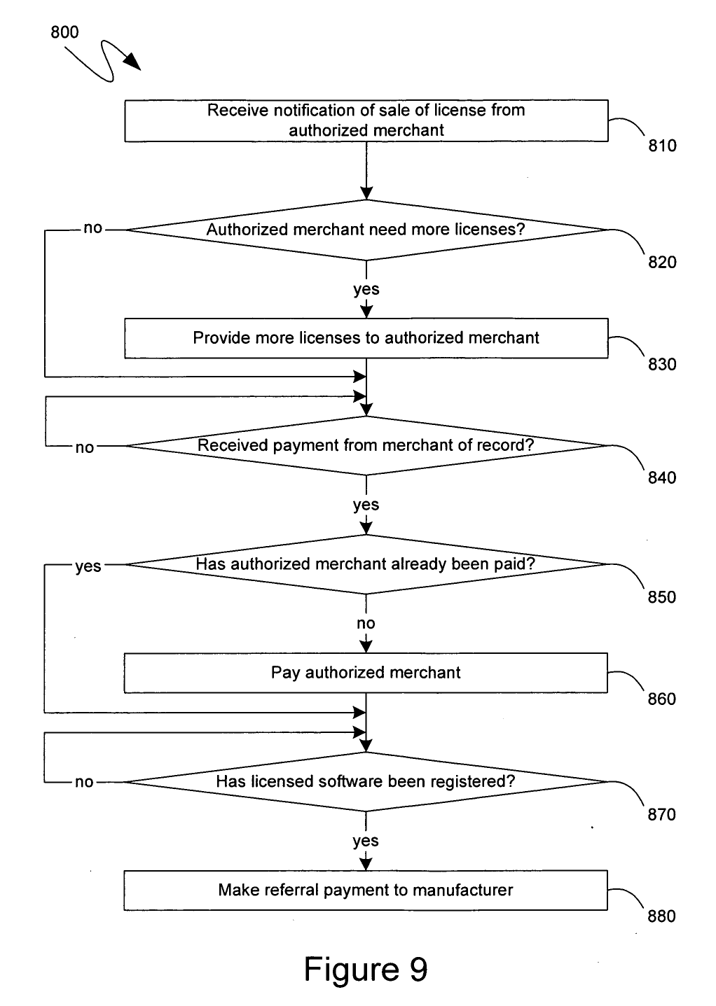

Once the online sale of the upgrade or software 11 to the user 40 is complete, the software developer 10 can be notified of the sale and can receive and distribute the user's payment. Turning to FIG. 9, a flow diagram 800 is shown, illustrating mechanisms that can be performed by the software developer 10 to support the system 99 of FIG. 1. As shown in FIG. 9, the software developer 10 can receive a notification of the sale of a license 12 from an authorized merchant 50 at step 810. Subsequently, at step 820, the software developer 10 can check if the authorized merchant 50 needs additional licenses and, if they do, the developer can provide those licenses to the authorized merchant at step 830.

After being notified of a sale of a license 12 at step 810, the developer 10 can check, at step 840, if the payment received for that sale has been sent by the merchant of record 60 that made that sale. If the payment has not yet been sent by the merchant of record 60, the developer 10 can, optionally, continue waiting for the payment before proceeding to step 850. Alternatively, the developer 10 can decide to proceed to step 850 even if the payment has not yet been received at step 840.

At step 850, the developer 10 can check whether the authorized merchant 50 has already been compensated for their efforts in managing and distributing licenses. In one embodiment, the developer 10 can compensate the authorized merchant 50 on a pre-defined and established basis, such that check 850 need not be performed every time the developer is notified of a sale at step 810. Consequently, step 850 is an optional step. If the developer 10 does determine that the authorized merchant 50 should be paid, such a payment can be made at step 860.

In one embodiment, the developer 10 can first check, at step 870, if the licensed software 11 has been registered. If the licensed software 11 has not yet been registered by the user 40, the developer 10 can wait and continue checking. Once it is determined at step 870 that the licensed software 11 has been registered by the user 40, the developer 10 can pay a referral payment to the manufacturer 20 at step 880. As indicated previously, by offering such a referral payment, the developer 10 can encourage manufacturers to provide software 11 that may have components or versions that are not active, despite the costs to the manufacturers of doing so. In an alternative embodiment, rather than waiting for the software 11 to be licensed at step 870, the developer 10 can proceed to step 880 and pay the referral payment to the manufacturer even if the software has not yet been licensed.

As can be seen from the above descriptions, mechanisms for providing efficient online sale of digital products can involve the cooperation of multiple independent parties. A system of identifications can enable each independent party responsible for an online sale to obtain a share of the proceeds, either by receiving payment from the user directly, or by receiving a referral payment from the developer of the digital products. To standardize the user's experience, and to offload management of digital licenses, a developer of digital products can rely on authorized merchants to maintain, manage and send the digital licenses when a purchase is made, either through the authorized merchant, or through a merchant of record. In view of the many possible variations of the subject matter described herein, we claim as our invention all such embodiments as may come within the scope of the following claims and equivalents thereto.

We claim:

1. A system for providing online purchasing of digital products guided by mutually beneficial rules agreed to by multiple parties, the system comprising:
multiple digital products provided together, the multiple digital products comprising at least one unlicensed digital product and a first license to at least one of the multiple digital products;
a second license to the at least one unlicensed digital product;
a promotional tool comprising a notification mechanism providing notification that the at least one unlicensed digital product is available for purchase, and a purchase request mechanism generating a purchase request, the purchase request comprising a product identifier of the at least one unlicensed digital product and a merchant of record identifier obtained from the multiple digital products;
a redirect service redirecting the purchase request to an authorized merchant hosting sales of the at least one unlicensed digital product on behalf of a merchant of record, identified by the merchant of record identifier, if the merchant of record is not authorized to itself host sales of the at least one unlicensed digital product; and
a license handing mechanism associating the second license with the at least one unlicensed digital product.

2. The system of claim 1, wherein the multiple digital products are multiple versions of a digital product family.

3. The system of claim 1, wherein the promotional tool further comprises an educational mechanism providing information regarding the at least one unlicensed digital product's features.

4. The system of claim 1, wherein the redirect service redirects the purchase request to the merchant of record, identified by the merchant of record identifier, if the merchant of record is authorized to itself host sales of the at least one unlicensed digital product.

5. The system of claim 1, wherein the second license is provided by a developer of the multiple digital products to the authorized merchant for distribution after a sale involving the merchant of record.

6. The system of claim 1, wherein the license handling mechanism is automatically invoked by a licensing receiving mechanism.

7. The system of claim 1, wherein the purchase request further comprises environmental information and wherein further the redirect service comprises a digital product selection mechanism selecting a specific digital product offered for purchase by the merchant of record based, at least in part, on the environmental information.

8. The system of claim 7, wherein the environmental information comprises geographic information and default language information.

9. The system of claim 1 further comprising a referral payment provided by a developer of the multiple digital products to a manufacturer bundling the multiple digital products, wherein the purchase request further comprises a manufacturer identifier obtained from the multiple digital products.

10. One or more computer-readable media comprising computer-executable instructions for redirecting purchase requests, the computer-executable instructions directed to steps comprising:
receiving a purchase request comprising a product identifier of at least one unlicensed digital product and a merchant of record identifier identifying a merchant of record;
determining if the merchant of record is authorized to itself host sales of the at least one unlicensed digital product;
redirecting the purchase request to an authorized merchant hosting sales of the at least one unlicensed digital product on behalf of the merchant of record if the merchant of record is not authorized to itself host sales of the at least one unlicensed digital product; and
redirecting the purchase request to the merchant of record if the merchant of record is authorized to itself host sales of the at least one unlicensed digital product.

11. The computer-readable media of claim 10 comprising further computer-executable instructions for selecting a specific digital product offered for purchase by the merchant of record based, at least in part, on environmental information, wherein the purchase request further comprises the environmental information.

12. The computer-readable media of claim 11, wherein the environmental information comprises geographic information and default language information.

13. The computer-readable media of claim 10 comprising further computer-executable instructions for redirecting the purchase request to an authorized merchant if the merchant of record was recently determined to be experiencing difficulties.

14. The computer-readable media of claim 10 comprising further computer-executable instructions for receiving updates associated with the at least one unlicensed digital product.

15. A method for providing online purchasing of digital products guided by mutually beneficial rules agreed to by multiple parties, the method comprising:
providing, to a manufacturer, multiple digital products together, the multiple digital products comprising at least one unlicensed digital product and a first license to at least one of the multiple digital products;
providing, to an authorized merchant, a second license to the at least one unlicensed digital product;
receiving notification from the authorized merchant of the sale of the second license, the notification comprising a manufacturer identifier;
receiving payment from a merchant of record that sold the second license; and
providing a referral payment to the manufacturer.

16. The method of claim 15, wherein the providing a referral payment is performed after receiving registration of the at least one unlicensed digital product.

17. The method of claim 15, wherein the at least one unlicensed digital product is a sub-feature of the at least one of the multiple digital products licensed by the first license, and wherein further the second license supercedes the first license.

18. The method of claim 15, further comprising:
receiving a purchase request comprising a product identifier of the at least one unlicensed digital product and a merchant of record identifier identifying a merchant of record;
determining if the merchant of record is authorized to itself host sales of the at least one unlicensed digital product;
redirecting the purchase request to the authorized merchant hosting sales of the at least one unlicensed digital product on behalf of the merchant of record if the merchant of record is not authorized to itself host sales of the at least one unlicensed digital product; and
redirecting the purchase request to the merchant of record if the merchant of record is authorized to itself host sales of the at least one unlicensed digital product.

19. The method of claim 18, further comprising: selecting a specific digital product offered for purchase by the merchant of record based, at least in part, on environmental information, wherein the purchase request further comprises the environmental information.

20. The method of claim 18, further comprising: evaluating whether the purchase request is valid given the product identifier of the at least one unlicensed digital product and a product identifier of the least one of the multiple digital products associated with the first license, wherein the purchase request further comprises the product identifier of the least one of the multiple digital products associated with the first license.
